(19) United States
(12) Patent Application Publication
(10) Pub. No.: US 2023/0043535 A1
(43) Pub. Date: Feb. 9, 2023

(54) MACHINE FOR ADDITIVE MANUFACTURING BY POWDER BED DEPOSITION WITH A CENTRAL GAS SUCTION OR GAS BLOWING MANIFOLD

(71) Applicant: AddUp, Cebazat (FR)

(72) Inventor: ALBIN EFFERNELLI, CEBAZAT (FR)

(21) Appl. No.: 17/786,801

(22) PCT Filed: Dec. 15, 2020
(86) PCT No.: PCT/FR2020/052452

§ 371 Date: Jun. 17, 2022

(30) Foreign Application Priority Data
Dec. 19, 2019 (FR) FR1914952

(51) Int. Cl. B29C 64/282; B29C 64/245; B29C 64/236; B29C 64/232; B22F 12/30; B22F 12/45; B22F 12/00; B33Y 30/00; B22F 10/25; B29C 64/153

(52) U.S. Cl. CPC B29C 64/282; B29C 64/245; B29C 64/236; B29C 64/232; B22F 12/30; B22F 12/45; B22F 12/224; B22F 12/222; B33Y 30/00; B22F 10/25; B29C 64/153

(57) ABSTRACT

A machine (10) for additive manufacturing by powder bed deposition comprises a work surface (12), a device (16) for selective consolidation, a device (18) for extracting the fumes, the selective consolidation device emitting at least two beams (F1, F2) of energy or heat. The work surface is divided into at least two work zones (Z1, Z2) adjacent to one another, and a first beam (F1) consolidates the powder in a first work zone (Z1) and a second beam (F2) consolidates the powder in a second work zone (Z2). The fume extraction device (18) comprises at least one central gas suction and/or gas blowing manifold (40) which is mounted to be translationally movable above an overlap zone (ZR) of the different adjacent work zones, and two side gas suction and/or gas blowing manifolds (42, 44) which are fixedly mounted and arranged on either side of the work surface, whcrcin the central manifold (40) extends at least over a maximum dimension of the work surface.

The present invention relates to additive manufacturing by powder bed deposition and fusion.

More precisely, the invention concerns the extraction of fumes produced by the fusion of powder above a build zone of large dimensions.

Document US 2015174823 concerns the additive manufacturing of large objects by powder bed deposition and fusion.

In order to guarantee a good fusion quality and avoid defects in the built objects, the fumes produced by fusion of the powder must be extracted. Indeed, these fumes may reduce the precision and/or the power of the energy or heat beams used to melt the powder.

The larger the dimensions of the built objects, the larger the work surface of the additive manufacturing machine and the greater the quantity of fumes produced by fusion of the powder. Also, the greater the distance between the fusion zone and the edges of the work surface, the more difficult it is to extract the fumes.

Document US 2015174823 proposes two embodiments of a fume extraction device in an additive manufacturing machine, intended to allow the extraction of fumes above a work surface of large dimensions. In the machine described in document US 2015174823, the work surface is divided into four work zones and four beams are used to consolidate the powder, each beam being associated with a work zone which is separate from the work zones associated with the other three beams.

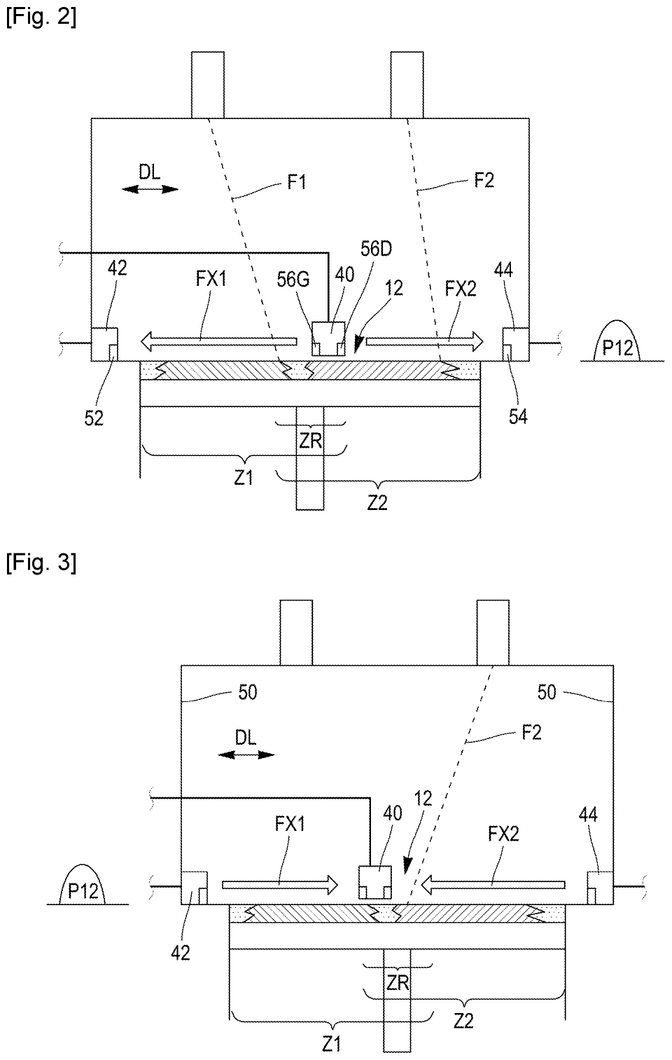

In a first embodiment illustrated in FIG. 2, the fume extraction device comprises two gas supply manifolds arranged on either side of the work surface, and a gas outlet taking the form of a suction nozzle arranged in the centre of the work surface in an overlap zone situated between the four work zones of the four beams.

In a second embodiment illustrated in FIG. 3, the fume extraction device comprises a gas supply nozzle arranged in the centre of the work surface in an overlap zone situated between the four work zones of the four beams, and two gas outlet manifolds arranged on either side of the work surface.

In the first embodiment of FIG. 2, the gas streams coming from the side manifolds converge towards the central suction nozzle, allowing the fume particles emitted by the consolidation work of the four beams in the four work zones to be extracted towards this nozzle.

This central arrangement of the suction nozzle is not optimal.

Firstly, the central position of the suction nozzle leads to densification of fume particles in the centre of the work surface, which may reduce the precision and/or power of the beams on approach to the central zone of the work surface.

Secondly, convergence of the separate streams towards the same central point may lead to the creation of turbulence which is liable to eject fume particles in different directions, and the fume particles thus ejected are liable to contaminate the walls of the build chamber and the windows through which the beams penetrate into the build chamber, or contaminate a new layer of powder before it is consolidated. Convergence of the separate streams towards a same central point may also lead to the creation of turbulence below the suction nozzle, which can lead to an accumulation of fume particles below the suction nozzle.

In the second embodiment of FIG. 3, the gas streams coming from the central gas supply nozzle diverge towards the side suction manifolds, in order to evacuate the fume particles, emitted by the consolidation work of the four beams in the four work zones, towards these manifolds.

This central arrangement of the gas supply nozzle is not optimal.

Firstly, by diverging, the gas streams lose speed and hence their efficacy in extracting the heavier fume particles.

Secondly, with such a configuration, certain zones of the work surface are not covered by gas streams with a laminar flow and constant speed. This is the case for example for the work surface zones situated in the median position between the lateral manifolds and remote from the gas supply nozzle, and for the zone situated below the gas supply nozzle.

In both embodiments described in document US 2015174823, the gas suction/supply nozzle must be kept at a sufficiently great height above the work surface to allow the beams to consolidate the powder located below the gas suction/supply nozzle. It is preferable that the gas streams used to extract the fume particles are situated as close as possible to the powder during consolidation, in order to extract the particles towards the gas outlets as quickly as possible, and to avoid these particles contaminating the surrounding powder or the walls of the build chamber and the windows through which the beams penetrate into the build chamber.

In both embodiments described in document US 2015174823, the gas streams circulating between the central nozzle and the side manifolds cannot be streams with constant speed and laminar flow, whereas the efficacy of streams used for extraction of fume particles is strongly linked to these two characteristics.

In both embodiments described in document US 2015174823, the central position of the gas supply or suction nozzle leads to the creation of zones in which the gas streams are turbulent, and/or the creation of dead zones over which gas streams do not flow, which evidently hinders the evacuation of fume particles.

Document EP3378584 proposes a fume extraction device in an additive manufacturing machine, intended to ensure the extraction of fumes above a work surface of large dimensions. To this end, it provides a first side gas blowing manifold, at least one central gas suction and blowing manifold, and a second side gas suction manifold.

In this document EP3378 584, the central suction and blowing manifold must be kept at a sufficiently great height above the work surface to allow the beams to consolidate the powder located below this central manifold. As FIG. 2 shows, part of the gas stream emitted by the first side blowing manifold travels as far as the second side suction manifold. This part of the stream which passes below the central manifold is liable to transport fume particles and any projections from the work zone of a first laser beam to the work zone of a second laser beam, and hence lead to contamination of a first work zone by the laser beam working within a second work zone. Evidently, this contamination is not desirable since it can lead to defects in the built objects.

The object of the present invention is to provide a technical solution which allows, in a build chamber of a machine for additive manufacturing by powder bed deposition, streams for extracting fumes close to a powder bed deposited on a work surface of large dimensions, for example more than 1 m² surface area, with constant speeds and laminar flows, while avoiding contamination of a first work zone of a first laser beam by a second laser beam assigned to a second work zone.

To this end, the object of the invention is a machine for additive manufacturing by powder bed deposition, the machine comprising a work surface on which at least one layer of additive manufacturing powder is deposited, the machine comprising a device for selective consolidation by complete or partial fusion of a layer of powder deposited on the work surface, and the machine comprising a device for extracting the fumes created by the selective consolidation of a powder layer, the selective consolidation device emitting at least two beams of energy or heat in the direction of the work surface, wherein the work surface is divided into at least two work zones adjacent to one another, and a first beam consolidates the powder in a first work zone and a second beam consolidates the powder in a second work zone.

According to the invention, the fume extraction device comprises at least one central gas suction and/or gas blowing manifold which is mounted so as to be translationally movable above an overlap zone of the different adjacent work zones, and two side gas suction and/or gas blowing manifolds which are fixedly mounted and arranged on either side of the work surface. Furthermore, the central manifold extends at least over a maximum dimension of the work surface in a transverse direction and moves translationally in a longitudinal direction perpendicular to the transverse direction, wherein the longitudinal and transverse directions are parallel to the plane of the work surface and of the powder.

Thanks to the combination of such a gas suction and/or blowing manifold with side gas suction and/or gas blowing manifolds, fume extraction streams with laminar flow and constant speed can be generated above work surfaces of large dimensions. Indeed, it is easier to create and maintain fume extraction streams with laminar flow and constant speed over short distances, and the central manifold allows the distance between the gas supply manifold(s) and the gas outlet manifold(s) to be divided across the entire width of the work surface.

Furthermore, thanks to the translational movability of a central manifold, fume extraction streams with constant speed and laminar flow can be generated over any zone of the work surface, and extremely close to the powder bed.

Still according to the invention, a central manifold is a gas blowing manifold, and the two side manifolds are gas suction manifolds, the central manifold allowing generation of a first gas stream towards a first side manifold and a second gas stream towards the second side manifold; or a central manifold is a gas suction manifold, and the two side manifolds are gas blowing manifolds, a first gas side manifold allowing generation of a first gas stream towards the central manifold and the second side manifold allowing generation of a second gas stream towards the central manifold.

Both these configurations avoid the transport of fume particles and any projections from one work zone to another, since the gas streams used on either side of the central manifold are directed in opposite directions.

Advantageously, but not necessarily, the invention may also provide that:
a central manifold also moves translationally in a retraction direction perpendicular to the longitudinal and transverse directions and to the plane of the work surface and of the powder,
when the work surface is arranged between two walls, the two side manifolds are provided in these walls,
each side manifold extends at least over a maximum dimension of the work surface in the transverse direction,
the selective consolidation device emits four beams of energy or heat towards the work surface, the work surface being divided into four work zones adjacent to one another, such that two mutually adjacent work zones are situated in the transverse direction and two mutually adjacent work zones are situated in the longitudinal direction, each beam consolidating the powder in a separate work zone,
when the work surface is divided into three consecutive work zones in the longitudinal direction: a first work zone, a second work zone, and a third work zone, the fume extraction device comprises a first central gas suction and/or gas blowing manifold which is mounted so as to be translationally movable above a first overlap zone situated between the first work zone and the second work zone, a second central gas suction and/or gas blowing manifold which is mounted so as to be translationally movable above a second overlap zone situated between the second work zone and the third work zone, and two side gas suction and/or gas blowing manifolds which are fixedly mounted and arranged on either side of the work surface.

Further features and advantages of the invention will become apparent from the following description. This description, which is given by way of non-limiting example, refers to the appended drawings, in which:

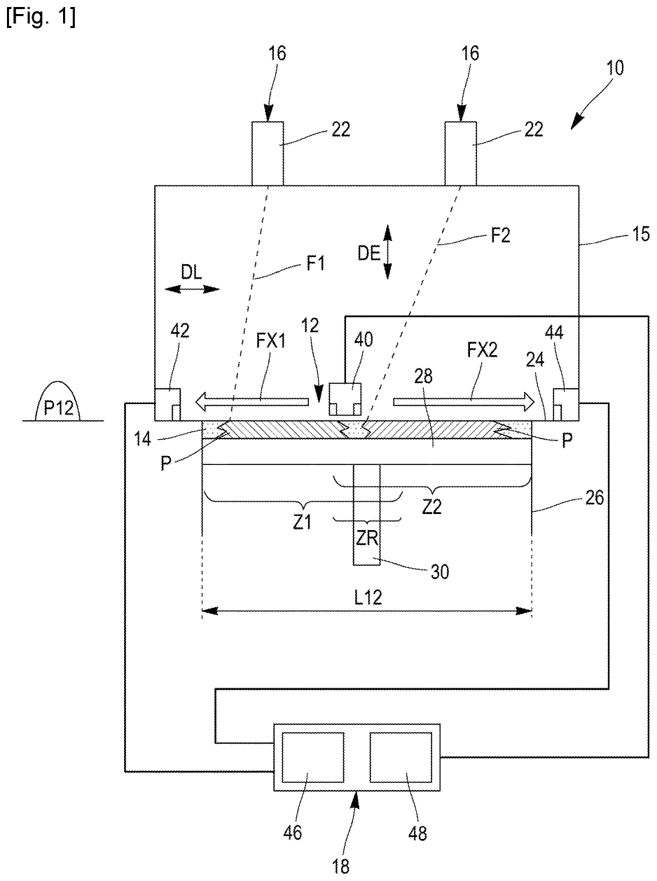

FIG. 1 is a schematic front view of a first embodiment of a machine according to the invention, with a central manifold in a first position,

FIG. 2 is a schematic front view of a first embodiment of a machine according to the invention, with a central manifold in a second position,

FIG. 3 is a schematic front view of a second embodiment of a machine according to the invention,

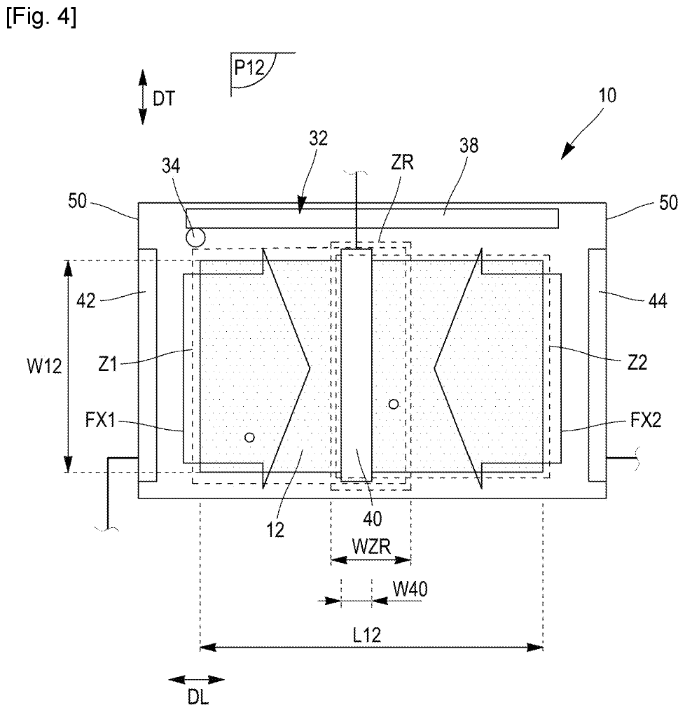

FIG. 4 is a schematic top view of a second embodiment of a machine according to the invention,

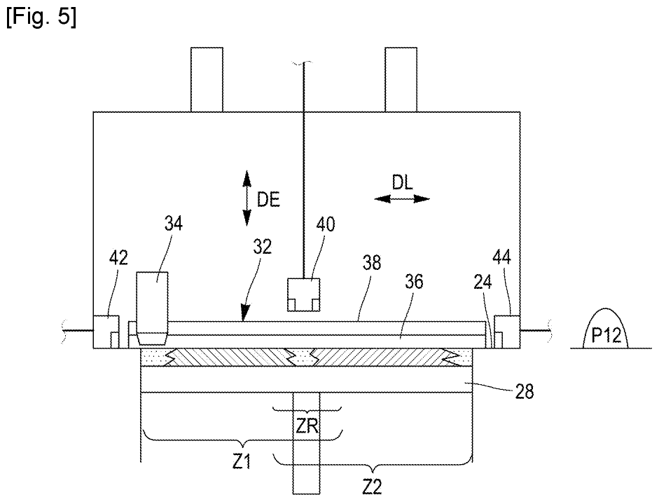

FIG. 5 is a schematic front view of the retraction of a central manifold in a machine according to the invention,

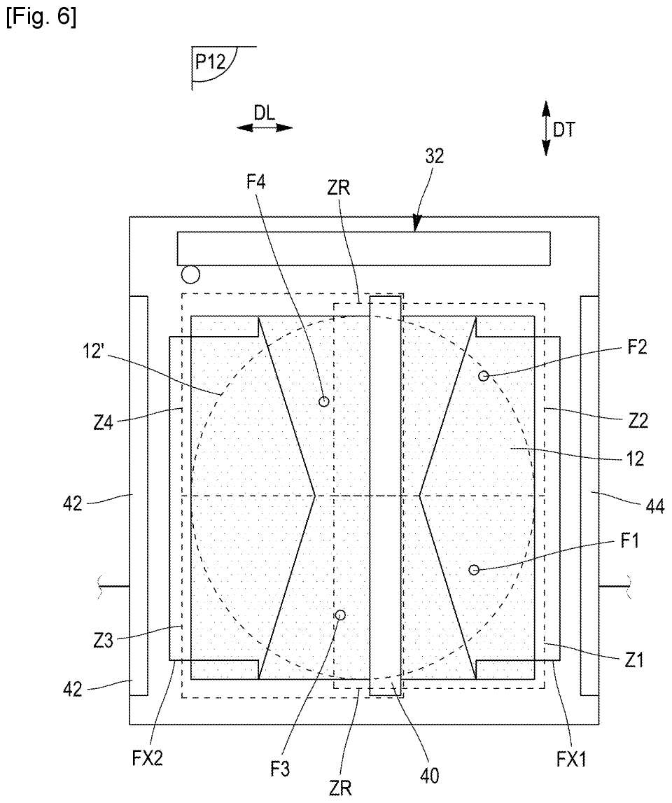

FIG. 6 is a schematic top view of a third embodiment of a machine according to the invention,

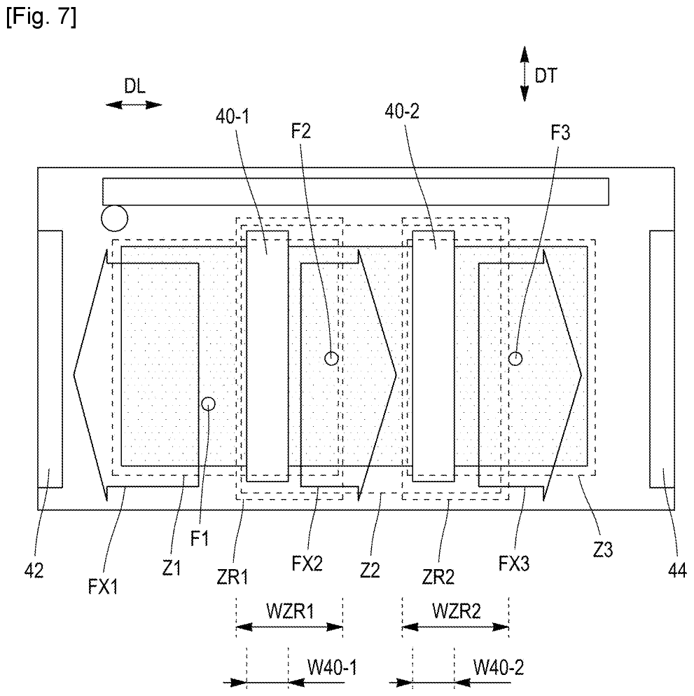

FIG. 7 is a schematic top view of a fourth embodiment of a machine according to the invention.

The invention relates to the extraction of fumes produced by the fusion of an additive manufacturing powder deposited on a work surface of a machine for additive manufacturing by powder bed deposition and fusion.

Additive manufacturing by powder bed deposition is an additive manufacturing method in which one or more parts are built by the selective consolidation of different layers of additive manufacturing powder superposed on one another. The first layer of powder is deposited on a support such as a plate, then selectively consolidated using at least one consolidation source along a first horizontal section of the part(s) to be built. Then, a second layer of powder is deposited on the first layer of powder which has just been consolidated, and this second layer of powder is then itself selectively consolidated, and so on up to the last layer of powder used for manufacturing the last horizontal section of the part(s) to be built.

The fusion consolidation source may be a source emitting a laser beam, a source emitting several laser beams, or a combination of several sources each emitting a laser beam.

A machine 10 for additive manufacturing by powder bed deposition and fusion according to the invention is illustrated schematically in FIG. 1.

This machine 10 comprises a work surface 12 on which at least one layer of additive manufacturing powder 14 is deposited.

Because of the fumes created by the powder fusion operations, the work surface 12 is preferably arranged in an enclosure 15 which can be hermetically sealed. A wall of this enclosure 15 may comprise a door giving access to the work surface.

An additive manufacturing powder may be metallic or non-metallic.

For implementing the additive manufacturing, the machine 10 comprises a device 16 for selective consolidation by complete or partial fusion of a layer of powder deposited on the work surface 12, and a device 18 for extraction of fumes created by the selective consolidation of a powder layer by fusion.

Because the work surface has large dimensions, for example over 1 m² to give an order of magnitude, the selective consolidation device 16 emits at least two energy or heat beams F1, F2 towards the work surface in order to reduce the time of consolidation by fusion. For example, the selective consolidation device 16 comprises two or four sources 22, each emitting a beam used to selectively consolidate the powder deposited on the work surface.

In the case of consolidation by laser beam, one source 22 is preferably situated outside the enclosure 15 and its beam penetrates into the enclosure through an opening provided in a wall of the enclosure and equipped with a window which is transparent to the wavelength of the beam passing through it.

In order to implement the selective consolidation, each laser beam source 22 is equipped with means allowing the emitted beam to be moved relative to the work surface and to modify the focal point of this beam in the plane of the powder layer to be consolidated.

As the machine 10 comprises a working plane 24, the work surface 12 is a flat surface defined within this working plane by an opening from which a build sleeve 26 extends. The build sleeve 26 extends for example from the working plane and below the working plane. For example, the working plane 24 is horizontal and the sleeve extends vertically and opens into the working plane. The work surface may be rectangular, circular, polygonal, annular or any other shape best adapted to the geometry of the object or objects to be built.

In order to support the different powder layers used in additive manufacturing of the objects P to be built, the machine 10 also comprises a build platform 28 which is translationally movable inside the sleeve under the effect of an actuator 30. For example, the build platform 28 slides vertically inside the build sleeve 26 under the effect of a ram.

As FIGS. 4 and 5 show, in order to produce the layer or different layers of powder used in additive manufacturing of the object or objects P to be built, the machine 10 comprises a powder deposition device 32 allowing deposition of at least one powder layer above the build platform 28. For example, this powder deposition device 32 comprises a movable powder reservoir 34 allowing deposition of a bead of powder on the working plane 24 in front of the work surface 12, and a powder spreading device 36 such as a roller or scraper mounted on a carriage 38 which is translationally movable above the work surface 12 and able to spread the powder of the bead over the work surface. Advantageously, the movable powder reservoir 34 may also be mounted on the carriage 38.

As the selective consolidation device 16 emits at least two beams F1, F2 of energy or heat towards the work surface, the work surface 12 is divided into at least two work zones Z1, Z2 adjacent to one another, a first beam F1 consolidating the powder in a first work zone Z1, and a second beam consolidating the powder in a second work zone Z2.

As FIG. 4 illustrates, two rectangular work zones Z1, Z2 may be adjacent in the length L12 of a rectangular work surface 12. Preferably, the different work zones have substantially equal surface areas. When the work surface 12 is circular, the adjacent work zones are for example quarters of a circle.

According to the invention, the fume extraction device 18 comprises at least one central gas suction and/or gas blowing manifold 40 which is mounted so as to be translationally movable above an overlap zone ZR of the different adjacent work zones Z1, Z2, and two side gas suction and/or gas blowing manifolds 42, 44 which are fixedly mounted and arranged on either side of the work surface 12.

Preferably, a central gas suction and/or gas blowing manifold 40 only moves translationally above an overlap zone ZR. In fact it is pointless for a central manifold 40 to move translationally above the entire work surface.

Preferably, the fume extraction device 18 also comprises a pump 46 and a device 48 for capturing fume particles, such as a filter, which are connected to one another and to the gas blowing and suction manifolds so as to form a closed gas-processing circuit passing through the enclosure 15 in which the work surface 12 is located. This closed gas-processing circuit in particular allows the introduction of clean gas into the enclosure 15 via one or more gas blowing manifolds, and the extraction of the gas loaded with fume particles from the enclosure 15 via the gas suction manifold or manifolds.

The gas used to extract the fumes is the same as that used to fill the enclosure 15. In the case that the enclosure 15 is under an inert atmosphere, the gas used to extract the fumes is the inert gas or the mixture of inert gas used to fill the enclosure 15.

According to the invention, a central manifold 40 extends at least over a maximum dimension of the work surface 12 in a transverse direction DT, and moves translationally in a longitudinal direction DL perpendicular to the transverse direction DT, wherein the longitudinal DL and transverse directions DT are parallel to the plane P12 of the work surface and of the powder, as FIGS. 1 to 7 show.

In the case that the work surface 12 is rectangular and its width W12 extends in the transverse direction DT and its length L12 extends in the longitudinal direction DL, a central manifold 40 extends at least over the entire width W12 of the work surface and moves translationally over at least part of the length L12 of the work surface.

In a first embodiment illustrated by FIGS. 1 and 2, a central manifold 40 is a gas blowing manifold, and the two side manifolds 42, 44 are gas suction manifolds, the central manifold allowing generation of a first gas stream FX1 towards a first side manifold 42 and a second gas stream FX2 towards the second side manifold. This first embodiment may guarantee that no fume particles or projections are transported by a gas stream from one work zone to another work zone.

In a second embodiment illustrated by FIG. 3, a central manifold 40 is a gas suction manifold, and the two side manifolds 44, 44 are gas blowing manifolds, a first side manifold 42 allowing generation of a first gas stream FX1 towards the central manifold, and the second side manifold 44 allowing generation of a second gas stream FX2 towards the central manifold.

In the first and second embodiments, the overlap zone ZR takes the form of a strip situated in the median position in the longitudinal direction and extending at least over a maximum dimensio of the work surface 12 in the transverse direction.

As illustrated in FIG. 5, a central manifold may also move translationally in a retraction direction DE perpendicular to the longitudinal DL and transverse directions DT and to the plane P12 of the work surface and of the powder, A central manifold 40 is translationally raised in the retraction direction DE so as to allow the powder spreading device 36 to move over the work surface 12 and below said manifold. Once the powder has been spread over the work surface, the central manifold 40 may be lowered as close as possible to the powder and participate in extraction of the fumes with the side manifolds 42, 44 during the selective consolidation of the powder.

In the case that the central manifold is not movable in the retraction direction DE, a central manifold may for example be displaced in the longitudinal direction DL sufficiently far away from the work surface 12 to allow the powder spreading device 36 to move over the work surface next to the central manifold which has been longitudinally displaced.

As described above, the work surface 12 is preferably arranged in an enclosure 15. An enclosure 15 in particular comprises side walls 50. Thus when the work surface 12 is arranged between two walls 50, the two side manifolds 42, 44 are provided in these walls 50. The side manifolds 42, 44 may be fully integrated in the walls 50 of the enclosure 15 or protrude into the enclosure 15, as illustrated on the figures.

As FIGS. 4, 6 and 7 show, each side manifold 42, 44 extends at least over a maximum dimension of the work surface 12 in the transverse direction DT. In the case that the work surface is rectangular, each side manifold 42, 44 extends at least over the entire width W12 of the work surface 12. Thus the manifolds can easily create between them the gas streams FX1, FX2 with constant speed and laminar flow, promoting rapid and effective extraction of the fume particles.

In a third embodiment of the machine according to the invention, as illustrated in FIG. 6, the selective consolidation device 16 emits four beams F1, F2, F3, F4 of energy or heat towards the work surface 12 in order to reduce the build time of large objects. The work surface 12 is divided into four work zones Z1, Z2, Z3, Z4 adjacent to one another, such that two mutually adjacent work zones are situated in the transverse direction DT and two mutually adjacent work zones are situated in the longitudinal direction DL, each beam consolidating the powder in a separate work zone.

In more detail, the first work zone Z1 is adjacent to the second work zone Z2 in the transverse direction DT and to the third work zone Z3 in the longitudinal direction DL, and the fourth work zone Z4 is adjacent to the third work zone Z3 in the transverse direction DT and to the second work zone Z2 in the longitudinal direction DL.

For example, the work surface 12 is square and comprises two rectangular work zones in its width W12, and two rectangular work zones in its length L12, the work zones being rectangular because of the overlap between the work zones.

In this third embodiment, the overlap zone ZR takes the form of a strip situated in the median position in the longitudinal direction DL and extending at least over a maximum dimension of the work surface 12 in the transverse direction DT. A first half of the overlap zone in the transverse direction belongs to the second Z2 and fourth Z4 work zones which overlap in the longitudinal direction DL, and a second half of the overlap zone in the transverse direction DT belongs to the first Z1 and third Z3 work zones which overlap in the longitudinal direction DL.

This third embodiment of the machine 10, with a division into four work zones Z1, Z2, Z3, Z4 and a central manifold 40, may advantageously be used for extraction of fumes above a circular work surface 12′ of large diameter (shown in dotted lines on FIG. 6), for example more than 1 m diameter.

In this third embodiment, a first stream FX1 sweeps the first and second work zones Z1 and Z2 between a first side manifold 44 and the central manifold 40, and a second stream FX2 sweeps the third and fourth work zones Z3 and Z4 between the second side manifold 42 and the central manifold 40.

In a fourth embodiment of the machine according to the invention, as illustrated on FIG. 7, the work surface 12 is divided into three work zones which are consecutive in the longitudinal direction DL: a first work zone Z1, a second work zone Z2 and a third work zone. The first work zone

Z1 is adjacent to the second work zone Z2 in the longitudinal direction DL, and the second work zone on one side adjoins the first work zone Z1 in the longitudinal direction DL and on a second side adjoins the third work zone Z3 in the longitudinal direction DL.

The fume extraction device 18 comprises a first central gas suction and/or gas blowing manifold 40-1 which is mounted so as to be translationally movable above a first overlap zone ZR1 situated between the first work zone Z1 and the second work zone Z2, a second central gas suction and/or gas blowing manifold 40-2 which is mounted so as to be translationally movable above a second overlap zone ZR2 situated between the second work zone Z2 and the third work zone Z3, and two side gas suction and/or gas blowing manifolds 42, 44 which are fixedly mounted and arranged on either side of the work surface 12.

Advantageously, the selective consolidation device 12 can emit three beams F1, F2, F3 of energy or heat towards the work surface 12, each beam consolidating the powder in a separate work zone. For example, a first beam F1 consolidates the powder in the first work zone Z1, a second beam F2 consolidates the powder in the second work zone Z2, and a third beam F3 consolidates the powder in the third work zone Z3.

For example, the work surface 12 is rectangular and the three work zones Z1, Z2, Z3 are also rectangular.

In this fourth embodiment, the overlap zones ZR1, ZR2 take the form of strips situated respectively at 1/3 and 2/3 of the dimension of the work surface 12 in the longitudinal direction DL, and these strips extend at least over a maximum dimension of the work surface 12 in the transverse direction DT. The first overlap zone ZR1 belongs to the first and second work zones Z1, Z2, and the second overlap zone ZR2 belongs to the second and third work zones Z2 and Z3.

In this fourth embodiment, a first stream FX1 sweeps the first work zone Z1 between the first central manifold 40-1 and a first side manifold 42, a second stream FX2 sweeps the second work zone Z2 between the first central manifold 40-1 and the second central manifold 40-2, and a third stream FX3 sweeps the third work zone Z3 between the second central manifold and the second side manifold 44.

In this fourth embodiment, at least one of the central manifolds is both a gas blowing manifold and a gas suction manifold.

In the various embodiments of the machine according to the invention, an overlap zone ZR, ZR1, ZR2, above which a central manifold 40, 40-1, 40-2 moves, has a dimension WZR, WZR1, WZR2, such as its width, which is at least twice as large as the dimension W40, W40-1, W40-2, such as the width, of the central manifold in the longitudinal direction DL. Thus by moving a central manifold on one side or the other of the overlap zone, any point of the overlap zone can be reached by a laser beam, and hence any powder grain present on the work surface can be melted by a laser beam even if the central manifold is arranged very close to the powder.

Thus the translation of a central manifold 40, 40-1, 40-2 in the longitudinal direction DL above an overlap zone ZR, ZR1, ZR2 of the work surface allows exposure of a first half of the overlap zone and a second half of the overlap zone alternately.

Ideally, an overlap zone ZR, ZR1, ZR2, above which a central manifold 40, 40-1, 40-2 moves, has a dimension WZR, WZR1, WZR2, such as its width, which is more than twice as large as the dimension W40, W40-1, W40-2, such as the width, of the central manifold in the longitudinal direction DL. In this way, there is a central part of the overlap zone ZR, ZR-1, ZR-2 which can be reached both by the beam or beams working on a first side of the central manifold, when this manifold is situated on a first side of the overlap zone, and by the beam or beams working on the other side of the central manifold, when the central manifold is situated on the other side of the overlap zone.

The dimension WZR, WZR1, WZR2, such as the width, of an overlap zone ZR, ZR1, ZR2 defines the useful travel length of the central manifold 40, 40-1, 40-2 in the longitudinal direction DL.

In the various embodiments of the machine according to the invention, and in order to extract the fumes as closely as possible to the powder, the side manifolds 42, 44 preferably lie on the work plane 24.

Ideally, the side manifolds 42, 44 and the central manifold(s) 40, 40-1, 40-2 allow generation of gas streams FX1, FX2, FX3 scraping the surface of the powder bed while retaining their laminar flow and constant speed.

For example, the openings 52, 54 through which the side manifolds 42, 44 suck or blow the gas are situated at the level of the work plane 24. Similarly, the lower edges of the right opening 56D and left opening 56G, through which a central manifold 40, 40-1, 40-2 blows or sucks the gas in order to extract fume particles, are preferably situated between 5 and 30 mm above the plane P12 of the work plane and the powder bed, thus avoiding the passage of part of the gas streams used below a central manifold. When a central manifold 40 is translationally raised in the retraction direction DE, the lower edges of the right 56D and left openings 56G of this manifold are situated between 50 and 300 mm above the plane P12 of the work plane and powder bed.

The openings 52, 54, 56D, 56G of the central manifolds 40, 40-1, 40-2 or side manifolds 42, 44 extend over the largest dimension, in particular the width W12, of the work surface in the transverse direction DT and may be equipped with diffusers: grilles or partitions dividing an opening into different ducts, or porous walls, in order to promote a laminar flow of the gas streams between the manifolds.

In the embodiments of the machine according to the invention, as illustrated on FIGS. 1 to 4, the streams FX1 and FX2 situated on either side of the central manifold are both incoming or both outgoing. The invention thus also covers embodiments of the machine according to the invention (not illustrated) in which a central manifold sucks in a first incoming stream and blows out a second outgoing stream.

Thanks to the presence of one or more central manifolds 40, 40-1, 40-2, the distances covered by the gas streams used to extract the fumes are divided into two, three etc., which guarantees a laminar flow of the flows with a constant speed.

Similarly, and also because of the reduction in the distances covered by the gas streams, the fume particles are extracted more rapidly, thus promoting the quality of fusion of the powder grains.

Thanks to its movability in the longitudinal direction DL, a central manifold 40, 40-1, 40-2 allows consolidation at any point of the work surface, while allowing positioning of said central manifold and hence the gas streams as close as possible to the powder.

1.-7. (canceled)

8. A machine (10) for additive manufacturing by powder bed deposition, the machine comprising:
a work surface (12) on which at least one layer of additive manufacturing powder (14) is deposited, the work surface being divided into at least two work zones (Z1, Z2) adjacent to one another;
a device (16) for selective consolidation by complete or partial fusion of a layer of powder deposited on the work surface, the selective consolidation device emitting at least two beams (F1, F2) of energy or heat in a direction of the work surface;
a device (18) for extracting fumes created by the selective consolidation of a powder layer,
wherein a first beam (F1) consolidates the powder in a first work zone (Z1) and a second beam (F2) consolidates the powder in a second work zone (Z2),
wherein the fume extraction device (18) comprises at least one central manifold (40) which is mounted so as to be translationally movable above an overlap zone (ZR) of the different adjacent work zones, and two side manifolds (42, 44) which are fixedly mounted and arranged on either side of the work surface,
wherein the at least one central manifold (40) extends at least over a maximum dimension of the work surface (12) in a transverse direction (DT) and moves translationally in a longitudinal direction (DL) perpendicular to the transverse direction,
wherein the longitudinal and transverse directions are parallel to a plane (P12) of the work surface and of the powder,
wherein the at least one central manifold (40) is a gas blowing manifold, and
wherein the two side manifolds (42, 44) are gas suction manifolds, the central manifold allowing generation of a first gas stream (FX1) toward a first side manifold and a second gas stream (FX2) toward the second side manifold.

9. The machine (10) according to claim 8, wherein the at least one central manifold (40) also moves translationally in a retraction direction (DE) perpendicular to the longitudinal and transverse directions and to the plane (P12) of the work surface and of the powder.

10. The machine (10) according to claim 8, wherein when the work surface (12) is arranged between two walls (50), and the two side manifolds (42, 44) are provided in the walls.

11. The machine (10) according to claim 8, wherein each side manifold extends at least over a maximum dimension of the work surface (12) in the transverse direction (DT).

12. The machine (10) according to claim 8, wherein the selective consolidation device (16) emits four beams (F1, F2, F3, F4) of energy or heat toward the work surface, the work surface being divided into four work zones (Z1, Z2, Z3, Z4) adjacent to one another, such that two mutually adjacent work zones are situated in the transverse direction (DT) and two mutually adjacent work zones are situated in the longitudinal direction (DL), each beam consolidating the powder in a separate work zone.

13. The machine (10) according to claim 8, wherein when the work surface (12) is divided into three consecutive work zones in the longitudinal direction (DL), a first work zone (Z1), a second work zone (Z2), and a third work zone (Z3), the fume extraction device (18) comprises a first central manifold (40-1) which is mounted so as to be translationally movable above a first overlap zone (ZR1) situated between the first work zone and the second work zone, a second central manifold (40-2) which is mounted so as to be translationally movable above a second overlap zone (ZR2) situated between the second work zone and the third work zone, and two side manifolds (42, 44) which are fixedly mounted and arranged on either side of the work surface.

14. A machine (10) for additive manufacturing by powder bed deposition, the machine comprising:
a work surface (12) on which at least one layer of additive manufacturing powder (14) is deposited, the work surface being divided into at least two work zones (Z1, Z2) adjacent to one another;
a device (16) for selective consolidation by complete or partial fusion of a layer of powder deposited on the work surface, the selective consolidation device emitting at least two beams (F1, F2) of energy or heat in a direction of the work surface;
a device (18) for extracting fumes created by the selective consolidation of a powder layer,
wherein a first beam (F1) consolidates the powder in a first work zone (Z1) and a second beam (F2) consolidates the powder in a second work zone (Z2),
wherein the fume extraction device (18) comprises at least one central manifold (40) which is mounted so as to be translationally movable above an overlap zone (ZR) of the different adjacent work zones, and two side manifolds (42, 44) which are fixedly mounted and arranged on either side of the work surface,
wherein the at least one central manifold (40) extends at least over a maximum dimension of the work surface (12) in a transverse direction (DT) and moves translationally in a longitudinal direction (DL) perpendicular to the transverse direction,
wherein the longitudinal and transverse directions are parallel to a plane (P12) of the work surface and of the powder,
wherein the at least one central manifold (40) is a gas suction manifold, and
wherein the two side manifolds (42, 44) are gas blowing manifolds, a first gas side manifold (42) allowing generation of a first gas stream (FX1) toward the central manifold and the second side manifold allowing generation of a second gas stream (FX2) toward the central manifold.

15. The machine (10) according to claim 14, wherein the at least one central manifold (40) also moves translationally in a retraction direction (DE) perpendicular to the longitudinal and transverse directions and to the plane (P12) of the work surface and of the powder.

16. The machine (10) according to claim 14, wherein when the work surface (12) is arranged between two walls (50), and the two side manifolds (42, 44) are provided in the walls.

17. The machine (10) according to claim 14, wherein each side manifold extends at least over a maximum dimension of the work surface (12) in the transverse direction (DT).

18. The machine (10) according to claim 14, wherein the selective consolidation device (16) emits four beams (F1, F2, F3, F4) of energy or heat toward the work surface, the work surface being divided into four work zones (Z1, Z2, Z3, Z4) adjacent to one another, such that two mutually adjacent work zones are situated in the transverse direction (DT) and two mutually adjacent work zones are situated in the longitudinal direction (DL), each beam consolidating the powder in a separate work zone.

19. The machine (10) according to claim 14, wherein when the work surface (12) is divided into three consecutive work zones in the longitudinal direction (DL), a first work zone (Z1), a second work zone (Z2), and a third work zone (Z3), the fume extraction device (18) comprises a first central manifold (40-1) which is mounted so as to be translationally movable above a first overlap zone (ZR1) situated between the first work zone and the second work zone, a second central manifold (40-2) which is mounted so as to be translationally movable above a second overlap zone (ZR2) situated between the second work zone and the third work zone, and two side manifolds (42, 44) which are fixedly mounted and arranged on either side of the work surface.
